(19) United States
(12) Patent Application Publication
(10) Pub. No.: US 2010/0138786 A1
(43) Pub. Date: Jun. 3, 2010

(54) User Interface Device with Display Screen and Memory for Pool/Spa Control System

(75) Inventor: Keith McQueen, Thousand Oaks, CA (US)

Correspondence Address: DORSEY & WHITNEY, LLP;INTELLECTUAL PROPERTY DEPARTMENT, 370 SEVENTEENTH STREET, SUITE 4700, DENVER, CO, 80202-5647, US

(73) Assignee: Zodiac Pool Systems, Inc., Moorpark, CA (US)

(21) Appl. No.: 12/628,003

(22) Filed: Nov. 30, 2009

Related U.S. Application Data
(60) Provisional application No. 61/118,972, filed on Dec. 1, 2008.

(51) Int. Cl. G06F 3/048; G06F 15/16; G06F 13/00; G06F 1/32; G06F 3/041; G09G 5/00

(52) U.S. Cl. 715/810; 709/217; 710/302; 713/323; 345/176; 345/156; 715/764

(57) ABSTRACT

Systems, devices and methods related to a user interface device for use in a pool/spa control system are provided. In accordance with one embodiment, there is provided a user interface device for a pool/spa control system that includes a processor and a memory for storing application programs that are performed by the processor. The user interface device also includes a connection port for interfacing with an external storage medium having one or more digital images and a display interface. The user interface device is configured to display the one or more digital images from the external storage medium in the display interface when the user interface device is otherwise idle with respect to sending instructions to the pool/spa control system.

### CROSS REFERENCE TO RELATED APPLICATION

The present application claims the benefit under 35 U.S.C. §119(e) to U.S. Provisional Patent Application No. 61/118,972, which was filed on Dec. 1, 2008, and entitled “User interface device with display screen and removable memory for pool/spa control system,” which is incorporated by reference into the present application in its entirety.

### BACKGROUND

Many different types of remote user interfaces have been developed for use with and for control of pool/spa control systems. Each of these different types of remote user interfaces was developed to meet various requirements of different customers or applications. For example, one remote user interface allows direct access to each of the controlled elements through buttons or actuators externally accessible on the interface. Another remote user interface has a simplified appearance with fewer buttons and relies on a menu-driven interface with the menus being shown on a display of the interface. The menus typically are navigated by a user pressing the buttons.

Generally, the user interface for a pool/spa control system is used for short periods of time. For example, the user interface is typically only used when the user accesses the control system, either to send a command or view a status of the pool/spa. Other than these short duration, sporadic usages, the user interface generally remains idle.

The information included in this background section of the specification, including any references cited herein and any description or discussion thereof, is included for technical reference purposes only and is not to be regarded as subject matter by which the scope of the invention is to be bound.

### SUMMARY

A user interface device with a display screen and a memory card socket for a pool/spa control system is dual-purposed as a digital picture frame. The user interface device harnesses the functionality of a full color display to serve a secondary function as a digital picture frame. The display may further include a touch screen for managing the functionality of both the pool/spa control system and the digital picture frame. The user interface device may further have a removable memory to allow for provision of a store of digital images for display on the device or transfer of digital images to an internal memory within the user interface device. Additionally, the memory may be used to provide pool/spa control programs.

In accordance with one implementation, there is provided a user interface device for a pool/spa control system that includes a processor and a memory for storing application programs that are performed by the processor. The user interface device also includes a connection port for interfacing with an external storage medium having one or more digital images, and a display interface. The user interface device is configured to display the one or more digital images from the external storage medium in the display interface when the user interface device is otherwise idle with respect to sending instructions to the pool/spa control system.

In accordance with another implementation, there is provided a method of operating a user interface device of a pool/spa control system. The user interface includes a display and at least one external storage device reader. The method includes activating the user interface device upon receiving user input and determining if the user input is related to control of the pool/spa control system. If the user input is not related to control of the pool/spa control system, it is determined if a removable storage is inserted into the user interface device. If a removable storage is inserted into the user interface device, an image is retrieved from the removable storage and provided to a display of the user interface device.

In accordance with yet another implementation, there is provided a method of operating a user interface device of a pool/spa control system. The user interface device includes a processor and at least one storage device. The method includes receiving user input and using the processor to start a first timer in response to receiving the user input. The process is also used to retrieve an image from storage and display the image on a display of the user interface device. A second timer is started and a standby mode is entered upon expiration of the first timer.

In accordance with yet another implementation, there is provided a method of operating a user interface device for a pool/spa control system. The user interface device includes a touch screen display and at least one device for reading removable storage media. The method includes using a processor for determining if a removable storage media is readable by the user interface device and for retrieving an image from the removable storage medium if the removable storage medium is determined to be readable by the user interface device. The retrieved image is displayed on the touch screen display of the user interface device.

In accordance with yet another implementation, there is provided a pool/spa control system. The system includes a control system and a user interface device communicatively coupled with the control system. The user interface device includes a processor, a memory coupled to the processor for storing operating instructions for the processor, and a display. The user interface device is configured to display images and operate as a digital picture frame when not communicating with the control system.

This summary section is provided to introduce a selection of concepts in a simplified form that are further described below in the Detailed Description. This summary section is not intended to identify key features or essential features of the claimed subject matter, nor is it intended to be used to limit the scope of the claimed subject matter. Other features, details, utilities, and advantages of the present invention will be apparent from the following more particular written description of various embodiments of the invention as further illustrated in the accompanying drawings and defined in the appended claims.

### BRIEF DESCRIPTION OF THE DRAWINGS

FIG. 1 is a simplified representation of a pool/spa control system with a remote user interface.

FIG. 2A is a front elevation view of the remote user interface of the pool/spa control system of FIG. 1.

FIG. 2B is a top view of the remote user interface of FIG. 2A.

FIG. 2C illustrates the remote user interface of FIG. 2A positioned within a cradle.

FIG. 3 illustrates an alternative embodiment of a remote user interface for the pool/spa control system of FIG. 1.

FIG. 4 is an exploded view of a first implementation of a user interface control system for a pool/spa incorporating a visual user interface and a removable memory card reader.

FIG. 5 is a schematic diagram of functional components of an exemplary control system for a pool/spa.

FIG. 6 is a flowchart illustrating the operation of the user interface of the pool/spa control system of FIG. 1 in accordance with an example embodiment.

FIG. 7 is a flowchart for using timers to control the display of images on the user interface of the pool/spa control system of FIG. 1.

FIG. 8 is a flowchart illustrating operating the user interface of the pool/spa control system of FIG. 1 as a digital picture frame when a memory card is inserted into the user interface.

FIG. 9 is a flowchart illustrating the use of a motion detector to actuate the user interface when motion is detected.

### DETAILED DESCRIPTION

In various implementations, a user interface device for an automated pool/spa control system allows a user to interact with the control system to control, program, and view the status of the system control system. The control system may have a power center board which is the brain of the system. The user interface may be remotely connected to the power center board via either a wired or wireless connection. The user interface is configured to read removable storage media and display images from the storage media when not interacting with the control system. As such, the user interface serves as both the user interface for interacting with the control system and for displaying of images.

It should be appreciated that providing the user interface as a digital picture frame to display images may be achieved in a variety of different ways. For example, in some implementations, the user interface may display images when the removable media is installed and can be read. In other implementations, the user interface may store images in local memory so that they may be displayed without the removable media installed. In yet other embodiments, the user interface may receive images for display wirelessly. Additionally, in some implementations, the user interface may display images for a set period of time before turning off or entering a sleep mode. Moreover, in some implementations, a motion sensor may be provided and used to turn on the user interface. As a default setting, in some implementations, the user interface may automatically display images.

Additionally, in some embodiments, the removable media may be used to update firmware and/or software of the user interface and/or a control system for the pool/spa. As such the provision of the removable media reader in the user interface may serve as a way to update the user interface and control system in addition to being a way to receive digital images for display.

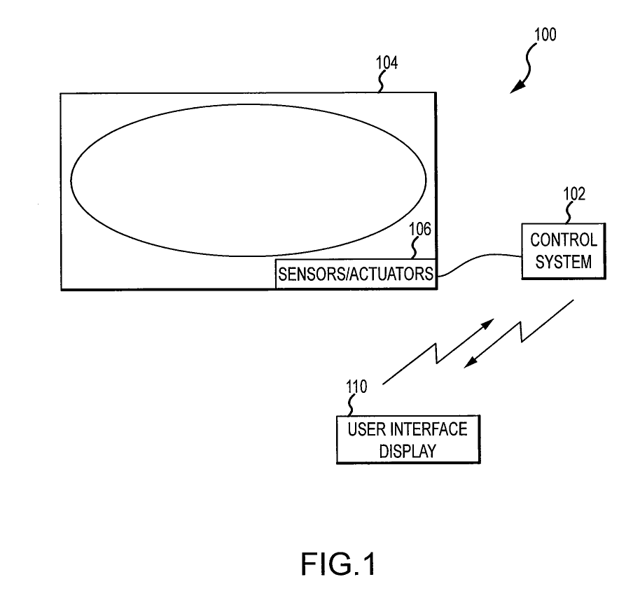

FIG. 1 illustrates a simplified pool/spa system 100 having a control system 102. The control system 102 monitors and controls the operation of the pool/spa 104 through sensors and actuators 106. The control system 102 includes the power center board which may include one or more processors and memory to allow for the control and monitoring functions to be performed automatically, or semi-automatically. The sensors and actuators 106 are communicatively coupled with the control system 102 and are used to determine conditions of and set operating parameters for the pool/spa 104. For example, sensors may be provided to determine a temperature of the water, a pH of the water, and/or other such conditions of the pool/spa 104. The information gathered by the sensors is then provided to the control system 102.

The actuators may be provided for a variety of purposes related to controlling the operating parameters of the pool/spa. For example, actuators may be used to add chemicals, call for maintenance, change temperature, and/or filter water. Additionally, in some embodiments, the actuators may operate water jet streams, oxygenate the water, turn on lights for the pool/spa 104, and/or operate a waterfall, fountain, or other aesthetic or functional device associated with the pool/spa 104. Each of the various functions performed by the actuators may be controlled by the control system 102.

The pool/spa system 100 also includes a user interface 110 which is communicatively coupled with the control system 102 to allow data to be passed between the control system 102 and the user interface 110. The control system 102 and user interface 110 may communicate through a suitable manner. For example, in some embodiments, they may communicate wirelessly and, in other embodiments, they may communicate via a cable, wire or fiber optic line. In one embodiment, the user interface 110 may be configured to communicate with the control system 102 via a wired connection while docked and a wireless connection when undocked.

The control system 102 may provide data to the user interface 110 regarding the conditions of the pool/spa 104. The user interface 110 may display the data for a user to review and, as such, the user interface 110 provides information to a user about the conditions of the pool/spa 104. Additionally, the user interface 110 allows the user to program and/or set the operating parameters for the control system and, thereby, control the conditions of the pool/spa 104. Specifically, upon receiving user input regarding the operating parameters for the pool/spa 104, the user interface 110 provides control signals to the control system 102 and the control system operates the pool/spa in accordance with those signals.

In addition to providing information to the user and operating as a remote control for the control system 102, the user interface 110 incorporates a digital picture frame function into the user interface 110 to leverage the display that would otherwise remain primarily dormant, thereby adding value to the user interface. The repurposing to provide digital picture frame functionality can be achieved with the addition of extra components to conventional pool/spa user interfaces. Specifically, the user interface 110 may be provided with an interface for accessing digital images, e.g., a memory card socket or a data communication port, and an additional software program to manage the functionality of the digital picture frame feature when the user interface 110 is otherwise idle.

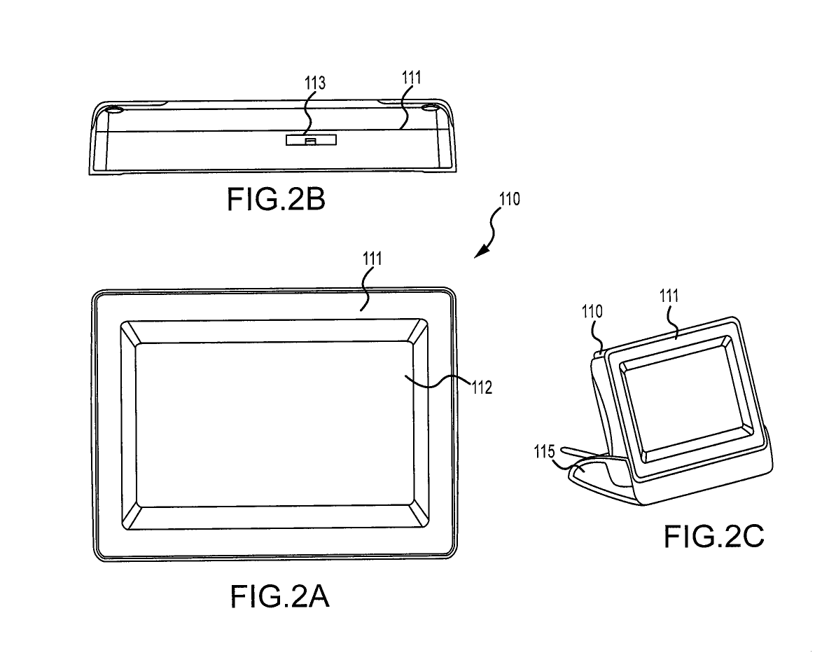

FIG. 2A illustrates a front elevation of an example user interface 110. The user interface 110 includes a display 112 for showing the operating parameters and other data received from the control system 102. The display 112 may be a full-color, backlit liquid crystal display (LCD), and organic LCD, or other suitable display device.

FIG. 2B illustrates a top view of the user interface 110 of FIG. 2A. As shown, the housing 111 of the user interface includes an aperture 113 for the receipt of removable memory. Other apertures (not shown) may also be provided within the housing 111 to allow for input and output devices and/or communication devices to be coupled to the user interface. Further, the housing 111 may include an aperture so that the user interface 110 may couple with a cradle. FIG. 2C illustrates the user interface 110 while coupled to a cradle 115. While coupled to the cradle 115, the user interface 110 may be coupled via wires to the control system 102 (FIG. 1). Additionally, a battery of the user interface 110 may charge while the user interface 110 is coupled to the cradle 115.

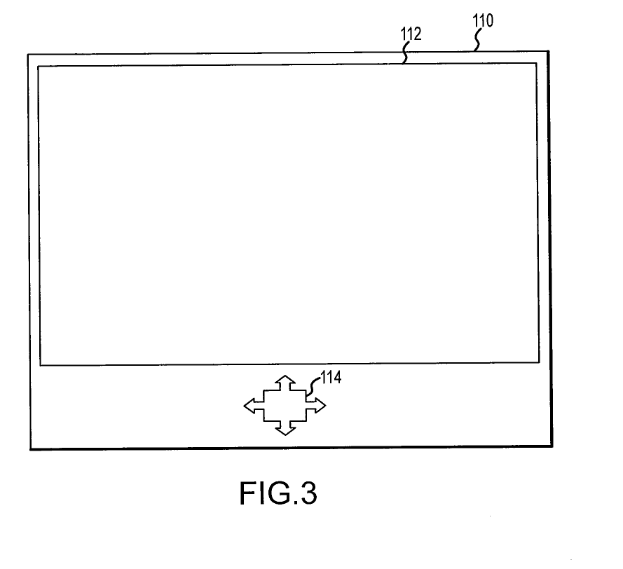

In some embodiments, the display 112 may include a touch screen overlay to enable a user input. In alternate embodiments shown in FIG. 3, the user interface 110 may also or alternatively receive user input via mechanical buttons 114 or switches.

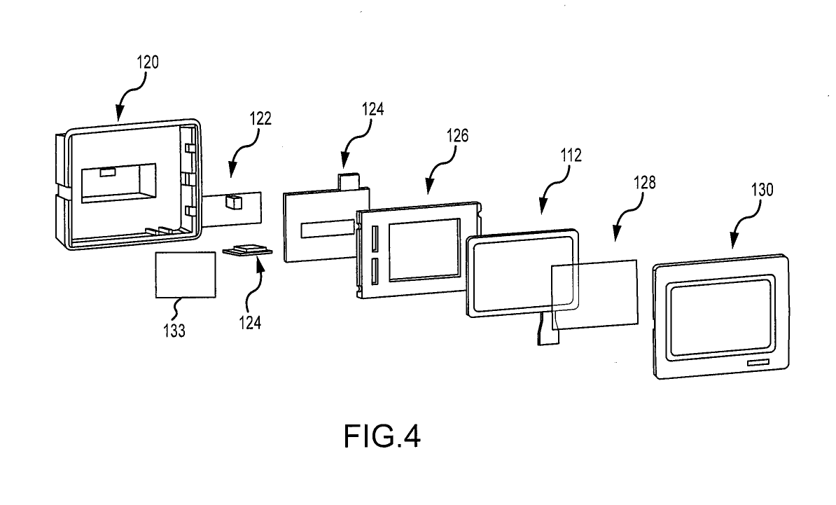

FIG. 4 illustrates an exploded view of the user interface 110 in accordance with an example embodiment. The user interface 110 includes a base housing 120, a power supply printed circuit board (PCB) 122, a card reader 124, a main PCB 126, an display support 128, the display 112, a touch panel 130, a face plate 132, and a battery 133. The power supply PCB 122 provides power to the user interface 110 and, in some embodiments, includes AC/DC inverters, voltage regulators, and/or other such components to help ensure proper power levels are provided to the user interface 110. The battery 133 may be operatively coupled to the power supply PCB 122, such that the battery 133 provides power to the user interface 110 when not coupled to an external power source. Additionally, the battery 133 may be configured to recharge when the power supply PCB 122 is coupled to an external power source, such as when the user interface is coupled with the dock 115 (FIG. 2C).

The user interface 110 for the pool/spa control system 100 may also incorporate a memory card slot or socket to allow the connection of an external memory card. Digital images, e.g., digital photographs taken by a user, can be stored in removable memory cards or other removable storage medium. Examples of external digital storage cards include those using the secure digital (SD), extreme digital (xD), multi-media card (MMC), memory stick (MS), and other types of solid state or flash memory card formats may be used in conjunction with the user interface 110 to function as a store of digital images for presentation on the display 112. These external memory cards may also be used to transfer new images into an internal memory of the user interface 110.

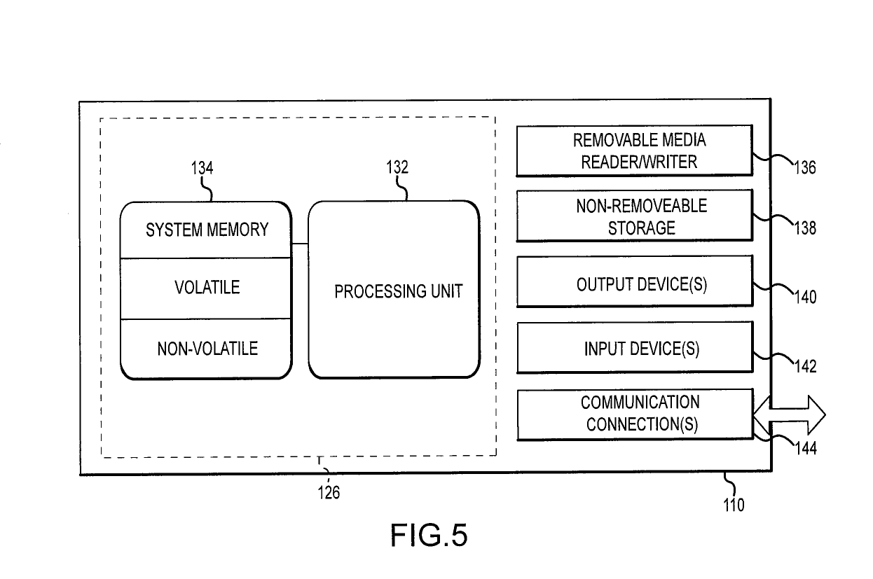

FIG. 5 illustrates a simplified block diagram of the user interface 110 in accordance with an example embodiment. The main PCB 126 (indicated by a dashed line) includes at least one processing unit 132 and a memory 134. The memory 134 is coupled to the processing unit 132 and may store instructions for the operation of the user interface 110. The memory 134 may be volatile (e.g., RAM), non-volatile (e.g., ROM and flash memory), or some combination of both. In some embodiments, the processing unit 132 and memory 134 may be discrete components mounted on the main PCB 126. In other embodiments, they may be included together along with other components and/or ports in an application specific integrated circuit (ASIC) or a system-on-chip (SOC) that may be mounted to the main PCB 126.

Additional components and/or devices may be provided with the user interface 110. These devices may include removable media readers/writers 136 for removable media and/or non-removable storage devices 138. Examples of removable media reader/writer 136 include memory card readers (e.g., memory card reader 124 (FIG. 4)), optical drives, and so forth. Storage media for the non-removable storage 138 may include volatile and nonvolatile media, and may be provided as, RAM, ROM, EEPROM, flash memory, CD-ROM, DVD, or other optical storage medium, magnetic cassettes, magnetic tape, magnetic disk, or other magnetic storage device, or other memory technology or medium that can be used to store data and can be accessed by the processing unit 132.

The user interface 110 may also have a variety of input devices 140 and output devices 142. Exemplary input devices 140 may include a keyboard, a mouse, a tablet, buttons, and/or the touch screen device 128. Exemplary output devices 140 may include the display 112 and speakers. Such input devices 140 and output devices 142 may be integrated with the user interface 110 or they may be connected to the user interface 110 via wires or wirelessly, e.g., via a Bluetooth protocol or infrared protocol.

The user interface 110 may also have one or more communication interfaces 144 that allow the user interface 110 to communicate with other devices, such as the control system 102, for example. The communication interface 144 may be connected with a network. The network may be a local area network (LAN), a wide area network (WAN), a telephony network, a cable network, an optical network, the Internet, a direct wired connection, a wireless network, e.g., radio frequency, infrared, microwave, or acoustic, or other networks enabling the transfer of data between devices. Data is generally transmitted to and from the communication interface 144 over the network via a modulated data signal, e.g., a carrier wave or other transport medium. The handling network communication transactions, may be performed by an operating system stored in the nonvolatile memory 134 and run by the processor 132.

Additionally or alternatively, the user interface 110 may be provided with a data connection port, for example, a universal serial bus (USB) port, WiFi, Firewire, Bluetooth, and other wired and wireless protocols to allow for transfer of digital images directly from a camera, computer, or other source to the internal memory of the user interface device. The memory card socket 124, or the data connection port may further be used for upgrades to the firmware and/or software of the user interface 110, the pool/spa control system 102, or other devices connected with the pool/spa control system 102. Hence, the memory card socket 124 may provide for reprogramming of the devices to add new features or fix software discrepancies, for example.

The operating instructions for the user interface 110 and the control system 102 may be updated in a variety of different ways. In one embodiment, the operating instructions of the user interface 110 and/or the control system 102 may be updated by accessing a website. The website may provide preset operating parameters for the pool/spa system 100 and/or may allow for user customization of the operating parameters such as how long to operate a pump, how much chemical to dispense, when to turn on and off lights, and the like. The website may be accessed via the user interface 110 or via another computing device such as a personal computer. As such, the instructions may be downloaded directly to the user interface 110 or the control system 102, or they may be downloaded to another computer and provided to the user interface 110 via a network connection or saved to a removable media that is provided to the user interface 110. In other embodiments, the user may access the user interface 110 and/or the control system 102 remotely via the Internet or other network connection to control the operating parameters for the pool/spa system or to retrieve a status update. Additionally, operating instructions may be saved to a removable storage medium and provided to the user interface 110 via the memory card socket 124, for example.

Moreover, in some embodiments, the user interface 110 may download images via a network connection or via the Internet. The downloading of images may result from a user prompt to do so or may automatically occur when the user interface 110 is on. That is, in one embodiment, the user interface 110 may be configured to access a website the contains images and download images from the website for display on the user interface 110 without user input. In some embodiments, the automatic download of images occurs if no images are stored locally or otherwise locally available (i.e., via a removable memory card). The images may be displayed on the user interface 110 and/or saved to removable media, such as a media card, for example. In some embodiments, a media card may include both images and operating instructions. When the media card containing both images and operating instructions is provided to the user interface 110, the user interface 110 may provide the operating instructions to the control system 102 so that the pool/spa system 100 may operate according to the operating instructions contained on the card, while the user interface 110 displays images from the card.

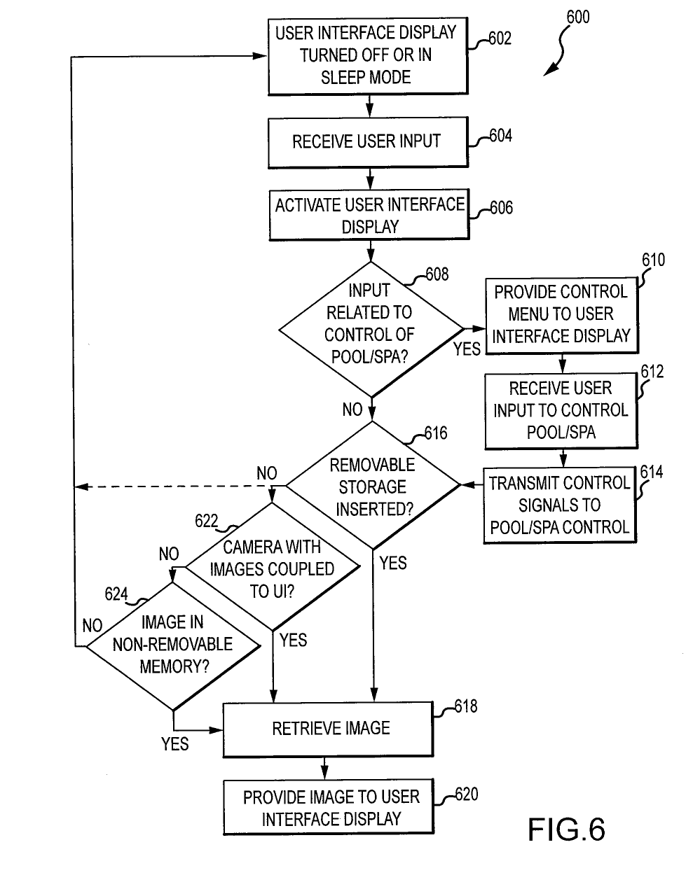

The user interface 110 may be operated in various different modes based on user preference and/or a particular configuration of the user interface 110. For example, FIG. 6 illustrates a method 600 of operating the user interface 110 to display images in accordance with an example implementation. Initially, the user interface 110 may be turned off or in a sleep mode (Block 602). Upon receiving user input (Block 604), the user interface 110 is activated (Block 606). The user input is then interpreted. Specifically, the user interface 110 determines if the received input is related to control of the pool/spa 104 (Block 608).

The determination of whether the user input is related to control of the system depends on the particular configuration of the user interface 110. In some embodiments, for example, if the user presses on the display (in a touch-sensitive display embodiment) for more than two seconds it may be interpreted as related to control of the system 100, whereas a tap on the display may be interpreted as simply awaking the user interface 110. It should be appreciated that the user interface 110 may be programmed in various and diverse manners to interpret input as either being related to control of the device or not.

If the user input is determined to be related to control of the pool/spa 104, a control menu is provided as an output on the display 112 of the user interface 110 (Block 610) and further user input that is directed to the control of the pool/spa 104 may be received (Block 612). In some embodiments, the user may select additional or alternative menus in order to alter some operating parameter of the pool/spa 104. For example, the user may adjust the operating temperature of the pool/spa 104 and/or adjust a countdown timer for water jets. Upon receiving the user input, control signals related to the user input are transmitted to the pool/spa control system 102 (Block 614) and the control system 102 may make appropriate adjustments and/or operate actuators to effectuate the user commands.

If the user input is determined to not be related to control of the pool/spa 104 and after control signals have been transmitted to the control system 102 if the user input is related to control of the pool/spa 104, it is determined if a removable storage medium (e.g., a memory card) is inserted into the user interface 110 (Block 616). If a removable storage medium is inserted into the user interface 110, images are retrieved from the removable storage medium (Block 618) and provided to the user interface 110 for display (Block 620).

In one embodiment, if no removable storage medium is inserted, the user interface 110 may be turned off or returned to a sleep mode (Block 602), as illustrated by the dashed line. In other embodiments, however, the user interface 110 may search for images from other sources. For example, the user interface 110 may search for a digital camera or other removable or external device that may be coupled to the user interface 110 and determine if any images are stored with the device (Block 622). Additionally, the user interface 110 may search local memory and non-removable memory for images (Block 624). If images are available, the images are retrieved (Block 618) and provided to the user interface display (Block 620).

In some embodiments, the display of images by the user interface 110 may be time limited. This feature may be particularly useful when the user interface 110 is not docked, as it may be relying on battery power for the display of the images. As such, the time limiting of display 112 operation may be a feature that is automatically activated when the user interface 110 is not docked and deactivated when the user interface 110 is docked or otherwise coupled to an external power supply.

Additionally, in some embodiments, the removable storage medium may include operating instructions for updating the firmware and/or software of the user interface 110, the control system 102, or both. For example, the user interface 110 may be configured to determine if the removable storage medium includes operation instructions. If the user interface 110 determines that the removable storage medium includes operating instruction, it may automatically or upon user prompt read the instructions and update firmware and/or software of the user interface 110 with the operating instructions of the removable storage medium. Additionally, in some embodiments, the user interface may read the operating instructions from the removable storage medium and provide the operating instructions to the control system 102. Hence, software and/or firmware for the control system 102 and/or user interface 110 may be updated with the operating instructions of the removable storage medium when the removable storage medium is read by the user interface 110.

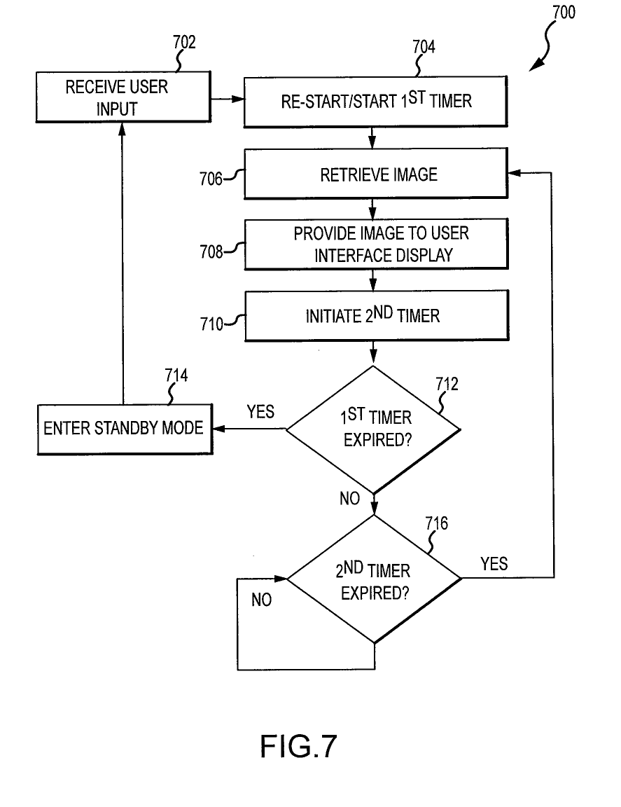

FIG. 7 illustrates an example technique 700 for limiting the amount of time that images are displayed on the user interface 110. Initially, user input is received (Block 702) and a 1^{st} timer is started (Block 704). The 1^{st} timer may be used to time the total amount of time the user interface 110 is on and the display 112 is in use. As such, the 1^{st} timer may be used in embodiments where only control system information is displayed as well as when images are displayed.

Upon starting the 1^{st} timer, an image is retrieved (Block 706) and provided for display by the user interface 110 (Block 708). The images may be retrieved from a non-removable storage medium, a removable storage medium or other source accessible by the processor 132. In one embodiment, if there is no removable storage medium, such as a memory card, installed the device may be configured to automatically check for images stored in a non-removable storage medium. In some embodiments, a user may load images from a removable storage medium to the non-removable storage medium for display by the user interface 110. Additionally, in some embodiments, the non-removable storage medium may store default images loaded by a manufacturer, reseller or servicer of the user interface devices 110.

Once the retrieved image is displayed, a 2^{nd} timer is started (Block 710). The 2^{nd} timer is used to determine (or limit) the amount of time that a particular image is displayed. As there may be multiple images available for playback, the 2^{nd} timer helps to ensure multiple images may be displayed while the user interface 110 is on.

In one embodiment, if a user wants a particular image to be displayed without being replaced, the second timer may be disabled by the user. For example, the user may access a menu related to the display of images and set the operating parameters for image display including disabling the display of images and/or disabling the automatic scrolling through available images. Additionally, a user may manually scroll through images by touching the display 112 or pressing buttons 114 (FIG. 3).

If the 1^{st} timer expires (Block 712), the user interface 110 may enter into a standby mode (Block 714) and wait for user input (Block 702) before displaying further images. The standby mode may be a power saving mode where the display is turned off, but the user interface 110 maintains images in the volatile memory ready for display. In other embodiments, the user interface 110 may turn completely off. In some embodiments, the user interface 110 may stay in a standby mode for a selected period of time before shutting off the user interface 110. For example, the user interface 110 may stay in a standby mode for 10 minutes or more. Upon receiving user input again, the 1^{st} timer is re-started. (Block 704) and the process is repeated.

If the 1^{st} timer has not expired, then it is determined if the 2^{nd} timer has expired (Block 716). If the 2^{nd} timer has not expired, the currently displayed image remains displayed. However, when the 2^{nd} timer expires, a new image may be retrieved (Block 706) and displayed (Block 708) and a the 2^{nd} timer is initiated again (Block 710). If there is only one image stored and available for display, the image remains displayed until the 1^{st} timer expires.

The timers may be implemented through one or more software routines stored in non-volatile memory or in non-removable memory. In some embodiments, the one or more of the length of time for the timers may be user configurable while in other embodiments, the timers may be preset during manufacture. Additionally, some embodiments may implement only one of the timers.

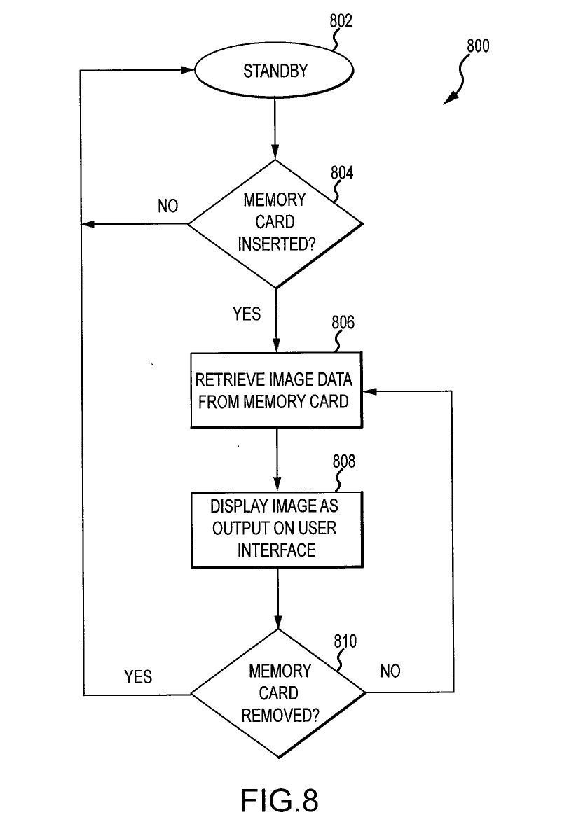

FIG. 8 is a flowchart illustrating yet another method 800 of operation for the user interface 110 in accordance with another embodiment. The method 800 begins with the user interface 110 in a standby mode (Block 802). Periodically, the user interface 110 may poll the memory card reader 124 to determine if a memory card has been inserted into the user interface 110 (Block 804). If no memory card has been inserted, the user interface remains in the standby mode (Block 802).

If a memory card is inserted into the user interface 110, image data is retrieved from the memory card (Block 806) and displayed by the user interface 110 (Block 808). The user interface 110 continues to periodically poll the memory card reader 124 to determine if the memory card has been removed from the user interface 110 (Block 810). As long as the memory card remains in the user interface 110, the user interface 110 retrieves images from the memory card (Block 806) and displays the images (Block 808). Once the user interface 110 determines that the memory card has been removed, however, the user interface ceases to display images and returns to the standby mode (Block 802).

The method 800, therefore, activates and deactivates the picture frame functionality based upon the presence of an external or removable source of image data. Accordingly, the method 800 may be applied to external or removable source of image data including, for example, a digital camera coupled to the user interface via a USB cable, a CD, DVD, or the like.

Additionally, in some embodiments, the user interface 110 may be configured to provide the images to other devices to allow images to be displayed on a different display. For example, in one embodiment, the user interface 110 may be configured to determine when an HDMI cable, or other such cable or device, is coupled to the user interface 110 and, when the HDMI cable is coupled to the user interface device 110, provide images over the HDMI cable to a larger display, such as a television or monitor near the pool/spa 104, for example.

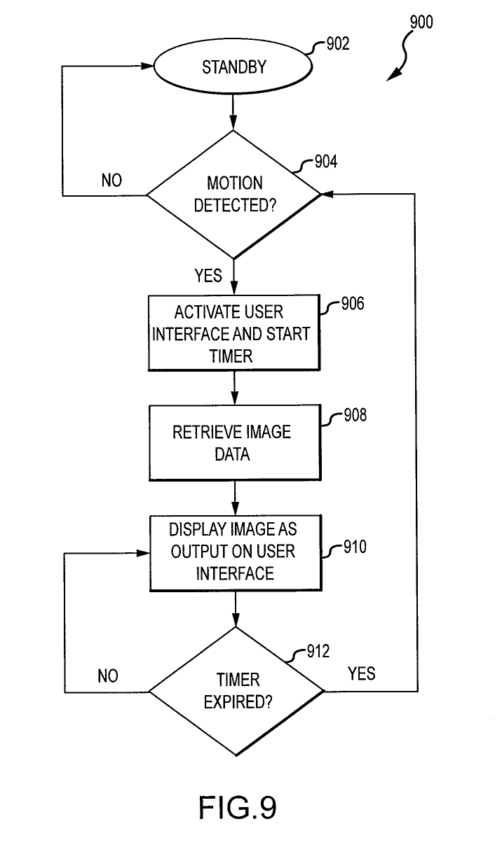

FIG. 9 illustrates a method 900 of actuating the user interface 110 as a digital picture frame when motion is detected, in accordance with an example embodiment. As shown, the user interface 110 may initially be in a standby mode (Block 902) and may remain in standby mode until motion is detected (Block 904). When motion is detected, the user interface is actuated (i.e., turned on) and a countdown timer may start (Block 906). Additionally, an image is retrieved (Block 908) and displayed on the user interface display (Block 910).

The user interface 110 determines when the timer has expired (Block 912). If the timer has not expired, the image remains displayed (Block 912). In some embodiments, where other images are available, the displayed image may periodically change. If the timer expires, it is determined whether movement has been detected again (Block 904). If motion has been detected, then the user interface remains on and the timer is reset (Block 906). If no motion is detected, the user interface 110 returns to the standby mode (Block 902).

It should be appreciated that other sensors and/or sensor technology may be used to achieve the same or similar functionality as the motion sensor. For example, proximity sensors may be implemented, such as IR and/or sonar sensors, or the like, to achieve the same or similar functionality.

It should be appreciated that the various methods, techniques and processes of described herein may be combined in whole or in part to achieve a desired functionality. For example, the method 600 may include the use of timers to prevent exhausting the battery 133 of the user interface 110 when not connected to an external power supply.

Further, the implementations described herein may be implemented as logical steps in one or more processing systems. The logical operations of the described systems, apparatus, and methods are implemented (1) as a sequence of processor-implemented steps executing in one or more systems and (2) as interconnected machine modules within one or more systems. The implementation is a matter of choice, dependent on the performance requirements of the control system or device implementing the described system, apparatus, and method.

Connection references included herein (e.g., attached, coupled, connected, and joined) are to be construed broadly and may include intermediate members between a collection of elements and relative movement between elements unless otherwise indicated. As such, connection references do not necessarily infer that two elements are directly connected and in fixed relation to each other. The exemplary drawings are for purposes of illustration only and the dimensions, positions, order and relative sizes reflected in the drawings attached hereto may vary.

The above specification, examples and data provide a description of the structure and use of exemplary embodiments of the invention. Although various embodiments of the invention have been described above with a certain degree of particularity, or with reference to one or more individual embodiments, those skilled in the art could make numerous alterations to the disclosed embodiments without departing from the spirit or scope of this invention. For example, it should be understood that the described user interface 110 may function as the control system 102 in one embodiment. Other embodiments are therefore contemplated. It is intended that all matter contained in the above description and shown in the accompanying drawings shall be interpreted as illustrative only of particular embodiments and not limiting. Changes in detail or structure may be made without departing from the basic elements of the invention as defined in the following claims.

What is claimed is:

1. A user interface device for a pool/spa control system comprising
a processor;
a memory for storing application programs that are performed by the processor;
a connection port for interfacing with an external storage medium having one or more digital images;
a display interface; wherein
the user interface device is configured to display the digital images from the external storage medium in the display interface when the user interface device is otherwise idle with respect to sending instructions to the pool/spa control system.

2. The user interface device of claim 1 further comprising a sensor or array of sensors superpositioned over the display interface and configured to operate in association with the display interface to receive user input.

3. The user interface device of claim 1 further comprising one or more antennas, the one or more antennas configured to wirelessly transmit instructions to a pool/spa control system and receive data from the pool/spa control system.

4. The user interface device of claim 1 wherein the device is configured to display data related to the operating parameters of the pool/spa.

5. The user interface device of claim 1 further comprising one or more buttons located on a housing of the user interface device and configured to receive user input.

6. The user interface device of claim 1 configured to couple with a cradle.

7. A method of displaying digital images on a user interface device of a pool/spa control system, the user interface including a display and at least one external storage device reader, the method comprising:
activating the user interface device upon receiving user input;
determining if the user input is related to control of the pool/spa control system;
if the user input is not related to control of the pool/spa control system, determining if a removable storage is inserted into the user interface device;
if a removable storage is inserted into the user interface device, retrieving an image from the removable storage; and
providing the image to a display of the user interface device.

8. The method of claim 7 further comprising:
if the user input is related to control of the pool/spa control system, providing a control menu to a display of the user interface device;
receiving user input to control the pool/spa control system; and
transmitting control signals to the pool/spa control system.

9. The method of claim 8 further comprising:
determining if a removable storage is inserted into the user interface device after transmitting control signals;
if a removable storage is inserted into the user interface device, retrieving an image from the removable storage; and
providing the image to a display of the user interface device.

10. The method of claim 7 further comprising turning off the display of the user interface device if no removable storage is inserted into the user interface device.

11. A method of displaying digital images on a user interface device of a pool/spa control system, the user interface device including a processor and at least one storage device, the method comprising:
receiving user input;
using the processor to start a first timer in response to receiving the user input;
using the processor to retrieve an image from storage;
using the processor to display the image on a display of the user interface device;
using the processor to start a second timer; and
entering a standby mode upon expiration of the first timer.

12. The method of claim 11 further comprising:
using the processor to retrieve another image upon expiration of the second timer; and
using the processor to restart the second timer.

13. The method of claim 11 further comprising restarting the first timer upon receiving user input.

14. A method of displaying images on a user interface device for a pool/spa control system, the user interface device including a touch screen display and at least one device for reading removable storage media, the method comprising:
using a processor for determining if a removable storage media is readable by the user interface device;
using a processor for retrieving an image from the removable storage medium if the removable storage medium is determined to be readable by the user interface device; and
using the processor to display the retrieved image on the touch screen display of the user interface device.

15. The method of claim 14 further comprising:
using the processor to determine if the readable removable storage medium is no longer readable by the user interface device; and
entering a standby state if the removable storage medium is no longer readable by the user interface device.

16. A pool/spa control system comprising:
a control system;
a remote control device communicatively coupled with the control system, the remote control device comprising:
a processor;
a memory coupled to the processor, the memory storing operating instructions for the processor; and
a display, wherein
the remote control device is configured to display images and operate as a digital picture frame when not communicating with the control system.

17. The pool/spa control system of claim 16 wherein the remote control device further comprises at least one removable storage medium reader, wherein further the displayed images are retrieved from a removable storage medium.

18. The pool/spa control system of claim 16 further comprising:
at least one sensor configured to collect data related to water conditions, wherein the at least one sensor is communicatively coupled to the control system and configured to provide the collected data to the control system; wherein
the control system is configured to provide the data related to the water conditions to the remote control device; and
the remote control device is configured to display the data related to the water conditions upon receiving input from a user requesting the data.

19. The pool/spa control system of claim 16 wherein the control system and the remote control device are configured to communicate wirelessly.

20. The pool/spa control system of claim 16 further comprising a cradle for the remote control device, the cradle configured to supply power to the remote control device when the remote control device is coupled to the cradle, and wherein the remote control device is configured to communicate with the control system via wired means while coupled to the cradle.

21. The pool/spa control system of claim 16 wherein the remote control device comprises at least one removable storage media reader, wherein further the remote control device is configured to read operating instructions from a removable storage medium and the system is configured to update operating instructions of at least one of the control system or the remote control device with the operating instructions read from the removable storage medium.
